(19) United States
(12) Patent Application Publication
(10) Pub. No.: US 2015/0206244 A1
(43) Pub. Date: Jul. 23, 2015

(54) SYSTEMS AND METHODS FOR PORTFOLIO CONSTRUCTION, INDEXING AND RISK MANAGEMENT BASED ON NON-NORMAL PARAMETRIC MEASURES OF DRAWDOWN RISK

(71) Applicant: Giovanni FULCI, MILANO (IT)

(72) Inventor: Giovanni FULCI, MILANO (IT)

(73) Assignee: MOVENGINEERING S.R.L.

(21) Appl. No.: 14/599,347

(22) Filed: Jan. 16, 2015

(30) Foreign Application Priority Data
Jan. 17, 2014 (IT) MI2014A000052

(51) Int. Cl. G06Q 40/06

(52) U.S. Cl. CPC G06Q 40/06

(57) ABSTRACT

A system, method and computer program for processing financial data in order to calculate and use new non-normal parametric measures of drawdown risk is disclosed, as well as a new set of portfolios construction techniques where the weights assigned to each single constituent asset are derived from this new measures. Risk measures based on drawdowns haven't received the extensive attention and use devoted to other common risk measures, due to the lack of an analytical understanding regarding how the drawdowns of a portfolio are related to those of its constituents. The present invention propose a solution to fill that gap, by developing: a new drawdown risk budgeting framework useful for portfolio allocation based on the drawdown contribution (marginal, total) to portfolio drawdown risk and drawdown correlation of its constituents; 4 different risk-based portfolio construction techniques useful for passive, enhanced-indexing and active portfolio management.

### BACKGROUND OF THE INVENTION

1. Field of the Invention

The present invention generally relates to new non-normal drawdown risk measures and their use and application and more particularly to portfolios and indices construction and risk management based on this new drawdown risk measures.

2. Related Art

It is well known in the art that the common flaw shared by both the traditional ways to asset allocation and the more recent innovation (i.e., max diversification) and rediscovered techniques like equal risk and minimum variance is that the risk engine behind them is almost always coming from the standard multivariate normal variance-covariance world. A recent survey (2011) between 229 financial institutional investors (mainly asset managers, pension funds and private bank/family office) showed that 60% estimate the covariance matrix via sample estimate, 42% using factor models and 4% with optimal shrinkage. The estimation error is mainly dealt with weight constraints (68%), Bayesian methods (15%), resampling 14%, and global minimum-risk portfolios (17%). The problems with normality assumption are well known in the art: the behaviour of financial asset returns empirically show fat tails, elevated negative skewness, serial correlation, with a realised frequency of large, negative return substantially higher than predicted by the normal distribution.

Moreover the recent financial crisis, and in general episodes of market stress, have shown that co-monotonic (i.e., common monotonic) behaviour on the downside of financial assets during periods of severe consecutive losses poses a serious challenge to the standard industry practices of portfolio construction and leads to portfolio's unanticipated extreme negative outcomes. From an investor's risk tolerance and risk management perspective, the path of loss, the absolute loss and the relationship between drawdown paths of the different assets within a portfolio are extremely relevant, both in absolute and relative return space (i.e., relative returns vs. a single market benchmark or a weighted composite of multiple market benchmarks). Given these evidences, for the practical aim of assessing risk, it's of paramount importance to take into account the relationship between potential sequences of losses (i.e., sequence of drawdowns) of portfolio's constituents. Drawdown can be defined as the drop of the current security/portfolio value compared to its previously achieved maximum up to the current moment t. It can be expressed in percentage terms or in absolute value terms.

The industry standard linear Pearson's correlation coefficient (Pearson's rho) is unfit for that aim, because it is a robust measure only under particularly stringent conditions (linear and concurrent relationship between the two variables; no or rare outliers with low magnitude of their distance from the estimated linear relationship; etc.). Notwithstanding that evidence, the Pearson's rho is at the hearth of most portfolio construction techniques available in the financial industry.

From previous works in the art, we know that, in the context of sub-additive risk measure, the co-monotonic additivity of two random variables can be interpreted as a specification of worst case scenario and nothing worse can occur than common monotonic random variables (Tasche, 2007), because the portfolio risk will be the sum of the two single risks (i.e., the two assets go down together and, for example, reach their maximum drawdown together). In that regard, the Pearson's rho is not useful, because it can be almost zero, even if the two random variables are comonotonic or counter-monotonic (Embrecht et al., 2001).

The problem of correlation, as used in the art today, is well known and it is a concern also to regulators in the art. The Basel Committee for Banking Supervision has recently released a consultative document (Fundamental Review of Trading Book, May 2012) where it is stated the will to impose a greater constraints on correlation assumptions across risk classes. In particular the Basel Committee believes that, given the “extremely unstable” estimates of correlation parameters, “particularly during time of stress”, the benefit of diversification (and hedging) should only be recognised “to the extent that it will remain during period of market stress”. The Committee concern is clearly related to the overestimation of diversification benefit “that don't materialise in time of stress”.

From a risk standpoint, the highest risk environment for a portfolio of two assets happens when the drawdown distributions of the same two assets show a common monotonic behaviour on the downside. The attempts by researchers and practitioners in the art has been mainly focused on the development of tools for the estimation of the strength of association between (daily, weekly, monthly, etc) returns distributions and not between cumulative drawdown distributions.

It remain a needs in the art regarding the estimation of the intensity of association between drawdown distributions, which is of paramount practical relevance from a diversification perspective, because the risk of mixing two assets can be additive in the cumulative drawdown dimension, but the tools available in the art aren't able to directly estimate this phenomenon. Filling that gap would be useful in the art, with methods and systems form portfolio construction and risk management able to take into consideration the few strong evidence of financial asset returns: the joint long left tails (i.e., the losses' tails) of asset drawdown distributions and the serial correlation/path dependency of each single historical series together with its relationship with other portfolio's assets.

The strong practical relevance of focusing on the behaviour of financial assets during their time spent in drawdown is reinforced by anecdotal observations that investors are mainly driven by a risk management perspective, with a time-dependent sensitivity to potential losses eventually defined by their “loss capacity” (absolute and/or relative to a liability) during the investment horizon and till expiry. That is in contrast with both the common asset allocation approach of using quadratic measure (i.e. volatilities and covariances, that implied a normal distribution of returns) multiplied by an unintuitive risk aversion parameter, and considering mainly the end-of-horizon expected risk-adjusted performance for the investment. It is possible to show that when risk is measured by variance, two assets can be judged quite dissimilar in terms of risk, whereas in terms of drawdown structure they are essentially the same (Garcia and Gould, 1987). Analogously, two assets can be judged quite similar in terms of variance, whereas in term of drawdown structure they are very different. Moreover, whereas risk measures used in the art, like value-at-risk, look at single loss at the end of the horizon (i.e., 1 day, 10 days, 1 year, etc), the uniqueness of the drawdown concept leans on its ability to takes into account the whole path, and hence also the evolution of the losses during the holding period; given its ‘memory’ and time-dependency, drawdown provides an important disclosure on the formation and sequence of the same losses in order to estimates the optimal time-dependent percentage of the portfolio to invest in risky assets given the loss absorption that portfolio's stakeholders are able to withstand.

The following review of the literature in the art focused on drawdown shows that the theme of drawdown correlation between drawdown distributions has not yet been addressed nor the decomposition of different measures of non-normal portfolio's drawdown risk in marginal and total contribution to the same measures portfolio's drawdown risk generated by its constituent assets, nor the correlation of the drawdown of each asset with the portfolio drawdown. Given the lack of the above, it's not yet available in the art a structured drawdown risk budgeting framework useful for risk management and portfolio construction.

Grossman and Zhou (G&Z, 1993) worked on a one-dimensional model with continuously rebalancing (between one risky asset and the risk-free) for portfolio optimization with a dynamic floor constraint in order to maximise the portfolio's long term growth rate, while controlling that the wealth process never falls below 100α % of its previous maximum, for some given constant αε(0;1). This “time invariant portfolio protection” strategy was first introduced by Estep and Kritzman (1988). Cvitanic and Karatzas (C&K, 1994) generalized the model of G&Z to multiple risky assets. More recently Yang and Zhong (2012) worked on a discrete implementation of the G&Z model, and to overcome the loss of optimality given the passage from continuous to discrete setting, introduced a rolling window to estimates drawdown, and assigned an equal value to the two original risk parameters of G&Z, namely the drawdown limit and the investor's risk aversion parameter. Chekhlov et al. (2000) maintained the multidimensional format of C&K and defined a family of drawdown functionals named conditional drawdown. The latter is similar to conditional value-at-risk, but in that case the loss function is defined by the drawdown distribution instead of the return distribution. In the context of hedge funds, Krokhmal et al. (2002) tested four different portfolio optimization constraints using a sample-path approach, namely the conditional drawdown, conditional value-at-risk, mean-absolute deviation and maximum loss. A database of Asia-Pacific hedge funds was used by Hakamada et al. (2007) to test the same portfolio optimization algorithm of Chekhlov et al. (2000) with constraints on conditional value-at-risk and conditional drawdown, on 108 hedge funds. Chekhlov et al. (2004) extended their previous work to a multi-scenario framework based on block-bootstrapping and defined and solved the related portfolio optimization problem applied to a simulated CTA's portfolio of 32 assets using three different measures: the conditional drawdown calculated over the 20% of the worst drawdown, the average and the maximum drawdown.

Whereas the previous works were based on historical data and simulation, Belentepe (2003) developed the analytical expression of drawdown density, the probability of drawdown exceeding a specific level, drawdown variance and expected drawdown (given the knowledge of μ, σ and t) based on the joint distribution of the underlying geometric Brownian motion (GBM) and its maxima by applying the reflection principle for Brownian motion. The limiting behaviour for t→∞ for the two drawdown statistics was also proposed. The GBM setting with drift was also used by Atiya et al, 2004 (A&M-I) to study the asymptotic behaviour (t→∞) of the expected maximum drawdown. The authors found that the scaling of expected maximum drawdown with t involves a “phase shift” from t to \sqrt{t} to log t depending on the specific value assumed by μ (respectively negative, zero, and positive). That solution however involves an infinite sum of integrals whose parameters were tabulated by the authors (Abu-Mostafa et al., 2003). Casati (2012) recovered via simulation based on GBM the analytical prediction of the ‘phase shift’ described in A&M-I (2004), and found that the distribution of maximum drawdown generated via simulation converges to a generalised extreme value distribution (GEV). Between other findings, the author also show that relaxing the iid assumption for the increments of the geometric process and considering an autoregressive process, the expected value of maximum drawdown almost linearly increase with the magnitude of the serial correlation coefficient. In the context of hedge funds, the impact of serial correlation in exacerbating drawdowns was studied by Haves (2006) and de Prado and Pejan (dP&P, 2004). dP&P also derived the analytical expression for time under water (i.e., the time spent in drawdown) for normally distributed returns. The results of extreme value theory were also used by Leal and Mendes (2005), that fitted a modified generalised Pareto distribution to drawdown data. An interesting contingent claim approach to hedge the maximum drawdown and the definition of sensitivities of these derivatives was developed by Vecer (2006) and Pospisil and Vecer (2008). Johansen and Sornette (J&S, 2008) focused on a systematic review and classification of market drawdowns/crashes outliers, that can be endogenous (as the ‘natural deaths of self-organized self-reinforcing speculative bubbles’ that become unsustainable according to a log-periodic power law signatures-LPPS) or exogenous (caused by extraordinary external perturbation or news). A renewed interest in looking at the drawdown as a risk statistic in the context of relative risk vs benchmark is represented in the article of Amenc et al. (2012).

The relationship between drawdown and Pearson's rho was explored by A&M-I (2004): they showed the beneficial impact of a decrease of the Pearson's rho on the Calmar ratio¹ for a portfolio of two assets with the same μ and σ. In a substantially different context, Takahashi and Yamamoto (T&Y, 2009) looked at correlation for the analytical pricing of option written on drawdown, in a stochastic volatility setting. The authors show that the volatility term is linearly related to the correlation between asset value and volatility state. In that case positive correlation increases expected drawdown and the standard deviation is lower. This setting provides that the option prices for drawdown decrease in ρ, because the dispersion of drawdown decrease. In terms of downside risk measure, Baghdadabad (2013) developed a portfolio optimization algorithm based on the co-maximum drawdown, as an extension in the drawdown dimension of previous researches on co-lower partial moments. The Calmar ratio is a risk-adjusted performance metric given by the following formula:

$$Calmar ( T ) = \frac{Performance [ 0 ; T ]}{Max Drawdown [ 0 ; T ]} .$$

The authors also developed an analytical approach to time-scale the Calmar ratio (see A&M-I, 2004).

Despite several years of research by academic and practitioners in the art regarding drawdown measures of risk, these hasn't been followed by the extensive industry interest devoted to other risk measures (i.e., volatility, value-at-risk, etc). That is due to the lack in the art, as of the date of the present invention, of an analytical understanding regarding how the drawdowns of a portfolio are related to the drawdowns characteristics of the individual instruments within the same portfolio. Substantially no practical solution has been found in the art to establish a parametric way (i.e. a closed form mathematical formulation) of calculating and linking the drawdown risk of a portfolio with the drawdown risk of its component assets in case of empirical and/or non-normal distributions. What is available in the art today are mainly methods for portfolio construction and optimization based on measures of portfolio historical or simulated drawdown risk, whereas drawdown is treated as objective or constraint. Historical drawdown is essentially calculated by looking at what have happened to the portfolio drawdown in the past, in doing so verifying the effective, realised evolution of the portfolio drawdowns. Simulated drawdown has the purpose of checking what could have been happened to the portfolio drawdown in the past, by imposing a set of weights (static and/or dynamic) to the portfolio constituents, and using the historical returns of each single portfolio constituent to build the historical series of returns and drawdown of the portfolio. Instead of using the historical returns of each single portfolio constituent, another approach to portfolio drawdown simulation is implemented by simulating the historical return of each portfolio constituent (and/or the portfolio as a whole): the simulations are performed based on selected distribution of returns (and/or mixture of distributions) and/or based on random sampling (simple bootstrap or block bootstrap) from the historical returns of the portfolio constituents (and/or from the portfolio as a whole).

### Nothing is Available in the Art for the Purpose of Explicitly Risk Budgeting in the Drawdown Dimensions for the Aims of Portfolio Construction, Indexing and Risk Management.

Thus a need remains in the art for methods and systems able to deliver a solution for this relationship, useful for portfolio construction and risk budgeting. A similar solution is also useful in providing a new set of risk information for portfolio construction and risk management, by decomposing the drawdown risk of a portfolio in marginal and total contribution to portfolio's drawdown risk generated by its constituent assets, or for understanding the correlation of the drawdown of each asset with the portfolio's overall drawdown risk and how to manage them as decision variables. This kind of risk information then are the building blocks for establishing a new risk budgeting framework that works in the drawdown dimension instead of the volatility dimension conventionally used in the art.

Moreover, it should be noted that in the last few years the interest by institutional investors (pension funds, etc) for risk-based indexing exposures is substantially increased, with the launch of several investment products and indices, with good commercial success, based on the following risk-based approach: minimum variance, minimum volatility, max diversification, equal risk weighting. It should also be noted that the equal risk weighting methodology has also been used in the art for multi-asset class portfolio allocation and risk budgeting and related asset allocation product. It should also be noted that all the above-mentioned risk-based approach are mainly based on manipulation of volatilities and covariances, with some variations, whose flaws were already discussed above.

The drawdown risk budgeting framework instead, by explicitly focusing on drawdown correlation, drawdown risk measures and drawdown contribution of each portfolio constituents, provides a more robust and effective approach in constructing portfolios that are less exposed to drawdown risk and with, on average, better risk-adjusted performance than the variance-covariance counterparts available in the art. This framework is hence useful in delivering a different and more robust approach to build risk-based portfolios. Risk-based portfolios are portfolios built by focusing only on measures of risk, in that way avoiding the layer of estimation error provided by the input of expected returns. In one embodiment, the present invention develops the following risk-based portfolios:
Equal Marginal Contribution to Drawdown Risk (EMCDR);
Equal Total Contribution to Drawdown Risk (ETCDR);
Maximum Drawdown Diversification (MDD, or Equal Drawdown Correlation, EDC);
Equal Drawdown Risk Measure (EDRM).
   each portfolio can be calculated based on 4 different specific Drawdown Risk Measures (DDRM).

The specific Drawdown Risk Measures considered for the present invention are the following: Average Drawdown (DDRM_AD); Percentile Drawdown (DDRM_PD); Conditional Drawdown-at-Risk (DDRM_CDAR); Maximum Drawdown (DDRM_MD).

By focusing on drawdown risk measures, it is possible to build drawdown risk efficient portfolios, instead of the classic mean-variance efficient portfolios and their variations available in the art. In that way it is possible establish a new system and method for building a set of portfolios that, based on a selected measure of portfolio non-normal drawdown risk (i.e. one of the new risk measures developed in the present invention), maximize a measure of portfolio returns, subject to a constraint given by the absolute level of the selected measure of non-normal portfolio drawdown risk. It is also possible to establish a new system and method for building a set of portfolios that, based on a selected measure portfolio returns, minimize a measure of portfolio non-normal drawdown risk, subject to a constraint given by the absolute level of the selected measure of portfolio returns. In both cases other constraints are possible.

In one embodiment, the advantage of using the system and method of the present invention for weighting set of securities (or group of securities) belonging to a market index or other pre-specified investable universe, is the higher risk-adjusted return (on average, with respect to the original market index) obtained by focusing on the drawdown risk budgeting dimensions. The rational explanation of the higher risk-adjusted return is the following: pairs of assets with strong drawdown correlation between them coupled with high drawdown risk show a persistent difficulties of recovering previous losses, due to the strong non-linear adverse effect of the compounding return: in order to recover a loss of 20% (50%) a positive performance of 25% (100%) is needed. The drawdown risk budgeting approaches operate by underweighting assets with strong drawdown correlation and/or higher drawdown risk and viceversa. In that way the system and method of the present invention reduce the exposure of the portfolio to these assets, with the advantage of shallower portfolio drawdown and quicker drawdown recovery.

The performance and results of the portfolio built with this new set of weights can be described and invested as an Index (or Enhanced Index). Assuming a starting value of 1000, the Index (or Enhanced Index) will vary according to the weighted performance of the underlying constituents, whose weights are derived from the application of the methods developed with the present invention.

In another embodiment, the systems and methods of the present invention then allow the portfolio analyst/asset allocator/risk manager to rebalance the portfolio weights as new data regarding the underlying securities (or group of securities) become available. The rebalancing can be done according to one of the standard methods available in the art (i.e., calendar rebalancing, threshold rebalancing, a mix of both, etc).

The new weights post-rebalancing are then applied to continue the historical series of the Index (or Enhanced Index).

### SUMMARY OF THE INVENTION

An exemplary embodiment of the present invention sets forth a system, method and computer program for processing financial data in order to calculate and use a new set of portfolios construction techniques where the weights assigned to each single constituent asset are derived from new measures of risk: the non-normal parametric measures of portfolio drawdown risk (non-normal Parametric Portfolio Drawdown Risk, PPDDR). Risk measures based on drawdowns haven't received the extensive attention and use devoted to other risk measures (i.e., volatility, value-at-risk, etc), due to the lack, as of the date of the present invention, of an analytical understanding regarding how the estimated drawdown risk of a portfolio is related to the estimated risk and performance characteristics of the individual instruments within the same portfolio. The present invention propose a solution to fill that gap, providing a relationship that is able to relate the drawdown measures of each asset to different measures of portfolio drawdown risk.

An exemplary embodiment of the present invention is directed to a new system, method and computer program product for the calculation of a new measure of drawdown correlation, ρ_{dd}, useful for the estimation of the intensity of association between the cumulative drawdown distributions of two financial instruments, which is entirely missing in the art, but it is of paramount practical relevance from a diversification perspective, because the risk of mixing two assets can be additive in the cumulative drawdown dimension. The use of the drawdown correlation, according to the exemplary embodiment of the present invention, allows to takes into account the risk that two assets show a linear or non-linear common monotonic behaviour in the cumulative drawdown dimension. The advantage of using the drawdown correlation leans on its ability to deal with the features of non-normality, non-linearity, path-dependency and common monotonicity so often found in financial market data during normal and dislocated/stressed market environments.

The availability of the drawdown correlation between two financial instruments, ρ_{dd}, according to an exemplary embodiment of the present invention, can be extended to higher dimension by writing an n×n matrix of the pairwise drawdown correlations between n financial instruments, P_{dd}.

In another exemplary embodiment of the present invention, by using the pairwise drawdown correlation matrix P_{dd} between each portfolio's asset together with the Diagonal Matrix (DM) of the absolute values of a specific Drawdown Risk Measure (DDRM) and substituting both respectively to the classic Pearson's rho correlation matrix and the volatility matrix, we obtain a parametric way to estimate a new set of measures of portfolio risk, the non-normal Parametric Portfolio Drawdown Risk (PPDDR), instead of portfolio volatility.

In particular, in another exemplary embodiment of the present invention, by substituting the drawdown correlation matrix P_{dd} to the classic Pearson's rho matrix and the diagonal matrix DM of a specific Drawdown Risk Measure (DDRM) to the volatility matrix, it is possible get a completely new matrix Σ_{DDRCM}, named Drawdown Risk Covariability Matrix (DDRCM), that is akin to the classic variance-covariance matrix, but calculated on the drawdown dimensions DDRM and P_{dd} already defined.

In an exemplary embodiment of the present invention, it is obtained a new parametric way to estimate the non-normal Parametric Portfolio Drawdown Risk (PPDDR), by taking the square root of a scalar formed by the multiplication of the row vector w of the portfolio weights of financial instruments considered for the inclusion in the portfolio and of Drawdown Risk Covariability Matrix (DDRCM) and a column vector w of the portfolio weights.

The systems and methods of the present invention calculate the non-normal Parametric Portfolio Drawdown Risk (PPDDR) according to different, specific Drawdown Risk Measures.

The specific Drawdown Risk Measures considered for the present invention are the following: Average Drawdown (DDRM_AD); Percentile Drawdown (DDRM_PD); Conditional Drawdown-at-Risk (DDRM_CDAR); Maximum Drawdown (DDRM_MD).

In one exemplary embodiment, if the specific Drawdown Risk Measure (DDRM) is the Average Drawdown (DDRM_AD), then the present invention obtains a new portfolio risk measure named non normal Parametric Portfolio Drawdown Risk_Average Drawdown (PPDDR_AD).

In one exemplary embodiment, if the specific Drawdown Risk Measure (DDRM) is the Percentile Drawdown (DDRM_PD), then the present invention obtains a new portfolio risk measure named non normal Parametric Portfolio Drawdown Risk_Percentile Drawdown (PPDDR_AD).

In one exemplary embodiment, if the specific Drawdown Risk Measure (DDRM) is the Conditional Drawdown-at-Risk (DDRM_CDAR), then the present invention obtains a new portfolio risk measure named non normal Parametric Portfolio Drawdown Risk_Conditional Drawdown-at-Risk (PPDDR_CDAR).

In one exemplary embodiment, if the specific Drawdown Risk Measure (DDRM) is the Maximum Drawdown (DDRM_MD), then the present invention obtains a new portfolio risk measure named non normal Parametric Portfolio Drawdown Risk_Maximum Drawdown (PPDDR_MD).

An exemplary embodiment of the present invention sets forth a system, method and computer program for processing financial data in order to calculate a new set of risk information useful for risk management, portfolio and index construction and related weighting purposes. An exemplary embodiment of the present invention establishes a new drawdown risk budgeting framework that is explicitly focused on pairwise drawdown correlation ρ_{dd}, specific Drawdown Risk Measures (DDRM), drawdown correlation of each portfolio constituent with the portfolio drawdown, and drawdown contribution of each portfolio constituents to the different measures of non normal Parametric Portfolio Drawdown Risk (PPDDR). By explicitly targeting the drawdown dimensions above-mentioned, the present invention provides a new and more robust approach in constructing portfolios that are less exposed to drawdown risk and with, on average, better risk-adjusted performance than their variance-covariance counterparts, and their variations, ubiquitously used in the art.

The rational explanation behind the practical usefulness of the present invention is that the better risk-adjusted performance delivered by the present invention lay on the ground that the higher the level of drawdown correlation the smaller and more asymmetric become the odds of obtaining positive portfolio performance, and viceversa; the allocation to asset with slightly negative or low positive drawdown correlation increase the odds of obtaining a positive performance and, at the same time, reduce the probability of getting strongly negative performance results from whose is harder to recover. Moreover, by focusing on measures of drawdown risk, the chances for the portfolio analyst and/or asset allocator and/or risk manager of being displaced by a complacent measure of risk (i.e., volatility, value-at-risk, ubiquitously used in the art) are lowered.

In one exemplary embodiment, the present invention develop a parametric drawdown risk budgeting framework, based on system, method and computer program product for calculating different dimensions of risk budgeting, useful for portfolio analyst (i.e., the portfolio manager, the portfolio asset allocator, or the risk manager, or the portfolio analyst) for analyzing and evaluating, for each financial instrument candidate for the inclusion in a portfolio of financial assets (or already within the portfolio) the magnitude of risk characteristics expressed by the following different dimensions of drawdown risk budgeting:
Marginal Contribution to Drawdown Risk (MCDR);
Total Contribution to Drawdown Risk (TCDR);
Drawdown Correlation of each asset within the portfolio with the portfolio itself (DC);
Specific Drawdown Risk Measures selected by the portfolio analyst: Average Drawdown
(DDRM_AD); Percentile Drawdown (DDRM_PD); Conditional Drawdown-at-Risk
(DDRM_CDAR); Maximum Drawdown (DDRM_MD).

Based on both the specific measures of non normal Parametric Portfolio Drawdown Risk (PPDDR), and the different dimension of the drawdown risk budgeting framework described above (i.e., MCDR, TCDR, DC, specific Drawdown Risk Measures), an exemplary embodiment of the present invention develop a system, method and computer program product useful for the construction of risk-based portfolios: these portfolios derive their portfolio weights based on the Equalisation (E) of the corresponding drawdown risk budgeting dimension, with 4 different approaches:
Equal Marginal Contribution to Drawdown Risk (EMCDR);
Equal Total Contribution to Drawdown Risk (ETCDR);
Maximum Drawdown Diversification (MDD, or Equal Drawdown Correlation, EDC),
Equal Drawdown Risk Measure (EDRM).
   In particular, in this exemplary embodiment of the present invention, each of the 4 risk budgeting dimensions can be calculated based on one of the 4 non normal Parametric Portfolio Drawdown Risk (PPDDR) described above, in that way obtaining 16 different risk-based portfolios.

In one exemplary embodiment of the present invention, if the portfolio risk measure selected by the portfolio analyst (i.e., the asset allocator, or the risk manager, or the portfolio analyst) is the non normal Parametric Portfolio Drawdown Risk_Average Drawdown (PPDDR_AD), then the corresponding specific risk-based portfolios built by the systems and methods of the present invention are the following:
Equal Marginal Contribution to Drawdown Risk (EMCDR) portfolio, based on the portfolio risk measure PPDR_AD, that is the PPDR_AD_EMCDR portfolio;
Equal Total Contribution to Drawdown Risk (ETCDR) portfolio, based on the portfolio risk measure PPDR_AD, that is the PPDR_AD_ETCDR portfolio;
Maximum Drawdown Diversification (MDD, or Equal Drawdown Correlation, EDC) portfolio, based on the portfolio risk measure PPDR_AD, that is the PPDR_AD_MDD portfolio (or PPDR_AD_EDC portfolio);
Equal Drawdown Risk Measure (EDRM) portfolio, based on the portfolio risk measure PPDR_AD, that is the PPDR_AD_EDRM portfolio;
According to one aspect, the portfolio analyst can use the system and method of the present invention to build portfolios that are the results of a weighted combination of the weights of 2 or more of the above portfolios built with the risk measure Parametric Portfolio Drawdown Risk_Average Drawdown (PPDDR_AD).

In one exemplary embodiment of the present invention, if the portfolio risk measure selected by the portfolio analyst (i.e., the portfolio manager, the asset allocator, or the risk manager, or the portfolio analyst) is the non normal Parametric Portfolio Drawdown Risk_Percentile Drawdown (PPDDR_PD), then the corresponding specific risk-based portfolios built by the systems and methods of the present invention are the following:
Equal Marginal Contribution to Drawdown Risk (EMCDR) portfolio, based on the portfolio risk measure PPDR_PD, that is the PPDR_PD_EMCDR portfolio;
Equal Total Contribution to Drawdown Risk (ETCDR) portfolio, based on the portfolio risk measure PPDR_PD, that is the PPDR_PD_ETCDR portfolio;
Maximum Drawdown Diversification (MDD, or Equal Drawdown Correlation, EDC) portfolio, based on the portfolio risk measure PPDR_PD, that is the PPDR_PD_MDD portfolio (or PPDR_PD_EDC portfolio);
Equal Drawdown Risk Measure (EDRM) portfolio, based on the portfolio risk measure PPDR_PD, that is the PPDR_PD_EDRM portfolio;
According to one aspect, the portfolio analyst can use the system and method of the present invention to build portfolios that are the results of a weighted combination of the weights of 2 or more of the above portfolios built with the risk measure Parametric Portfolio Drawdown Risk_Percentile Drawdown (PPDDR_PD).

In one exemplary embodiment of the present invention, if the portfolio risk measure selected by the portfolio analyst (i.e., the asset allocator, or the risk manager, or the portfolio analyst) is the non normal Parametric Portfolio Drawdown Risk_Conditional Drawdown at Risk (PPDDR_CDAR), then the corresponding specific risk-based portfolios built by the systems and methods of the present invention are the following:
Equal Marginal Contribution to Drawdown Risk (EMCDR) portfolio, based on the portfolio risk measure PPDR_CDAR, that is the PPDR_CDAR_EMCDR portfolio;
Equal Total Contribution to Drawdown Risk (ETCDR) portfolio, based on the portfolio risk measure PPDR_CDAR, that is the PPDR_CDAR_ETCDR portfolio;
Maximum Drawdown Diversification (MDD, or Equal Drawdown Correlation, EDC) portfolio, based on the portfolio risk measure PPDR_CDAR, that is the PPDR_CDAR_MDD portfolio (or PPDR_CDAR_EDC portfolio);
Equal Drawdown Risk Measure (EDRM) portfolio, based on the portfolio risk measure PPDR_CDAR, that is the PPDR_CDAR_EDRM portfolio;
According to one aspect, the portfolio analyst can use the system and method of the present invention to build portfolios that are the results of a weighted combination of the weights of 2 or more of the above portfolios built with the risk measure Parametric Portfolio Drawdown Risk_Conditional Drawdown at Risk (PPDDR_CDAR).

In one exemplary embodiment of the present invention, if the portfolio risk measure selected by the portfolio analyst (i.e., the asset allocator, or the risk manager, or the portfolio analyst) is the non normal Parametric Portfolio Drawdown Risk_Maximum Drawdown (PPDDR_MD), then the corresponding specific risk-based portfolios built by the systems and methods of the present invention are the following:
Equal Marginal Contribution to Drawdown Risk (EMCDR) portfolio, based on the portfolio risk measure PPDR_MD, that is the PPDR_MD_EMCDR portfolio;
Equal Total Contribution to Drawdown Risk (ETCDR) portfolio, based on the portfolio risk measure PPDR_MD, that is the PPDR_MD_ETCDR portfolio;
Maximum Drawdown Diversification (MDD, or Equal Drawdown Correlation, EDC) portfolio, based on the portfolio risk measure PPDR_MD, that is the PPDR_MD_MDD portfolio (or PPDR_MD_EDC portfolio);
Equal Drawdown Risk Measure (EDRM) portfolio, based on the portfolio risk measure PPDR_MD, that is the PPDR_MD_EDRM portfolio;
According to one aspect, the portfolio analyst can use the system and method of the present invention to build portfolios that are the results of a weighted combination of the weights of 2 or more of the above portfolios built with the risk measure Parametric Portfolio Drawdown Risk_Maximum Drawdown (PPDDR_MD).

Based on both the specific measures of non normal Parametric Portfolio Drawdown Risk (PPDDR), and the different dimension of the drawdown risk budgeting framework described above (i.e., MCDR, TCDR, DC, specific Drawdown Risk Measures), an exemplary embodiment of the present invention develop a system, method and computer program product useful for the construction of risk-based portfolios: these portfolios derive their portfolio weights based on the Qualitative and/or Quantitative evaluation (QQ), performed by the portfolio analyst, of the corresponding drawdown risk budgeting dimensions, provided by the systems and methods of the present invention, that is:
QQ Marginal Contribution to Drawdown Risk (QQMCDR);
QQ Total Contribution to Drawdown Risk (QQTCDR);
QQ Drawdown Diversification (QQMDD, or QQ Drawdown Correlation, QQDC),
QQ Drawdown Risk Measure (QQDRM).
   In particular, in this exemplary embodiment of the present invention, each risk-based portfolio can be generated based on one of the non normal Parametric Portfolio Drawdown Risk (PPDDR) described above.

By focusing on non normal Parametric Portfolio Drawdown Risk measures, it is possible to build an efficient frontier of drawdown risk portfolios (EF_PPDDR), instead of mean-variance efficient frontier portfolios (and its variations) ubiquitous in the art. In that way the systems and methods of the present invention build a set of portfolios that, based on a selected measure of non-normal Parametric Portfolio Drawdown Risk, PPDDR, maximize a measure of portfolio returns, subject to a constraint given by the absolute level of the selected measure of PPDDR.

In one embodiment, if the selected measure of non-normal Parametric Portfolio Drawdown Risk, PPDDR is the Average Drawdown (PPDDR_AD), then the corresponding efficient frontier of average drawdown risk portfolios is the EF_PPDDR_AD.
In one embodiment, if the selected measure of non-normal Parametric Portfolio Drawdown Risk, PPDDR is the Percentile Drawdown (PPDDR_PD), then the corresponding efficient frontier of percentile drawdown risk portfolios is the EF_PPDDR_PD.
In one embodiment, if the selected measure of non-normal Parametric Portfolio Drawdown Risk, PPDDR is the Conditional Drawdown-at-Risk (PPDDR_CDAR), then the corresponding efficient frontier of conditional drawdown at risk portfolios is the EF_PPDDR_CDAR. In one embodiment, if the selected measure of non-normal Parametric Portfolio Drawdown Risk, PPDDR is the Maximum Drawdown (PPDDR_MD), then the corresponding efficient frontier of maximum drawdown portfolios is the EF_PPDDR_MD.
The measure of portfolio returns is generally given by the weighted returns of the portfolio constituents. The return of each portfolio constituent could be qualitatively and/or quantitatively formulated by the portfolio analyst and loaded in the computer program by the portfolio analyst. Other measure of portfolio returns are possible (i.e., historical realised portfolio returns for a given portfolio rebalancing method) without affecting the present invention.

In another embodiment, the specific risk-based portfolios built by the systems and methods of the present invention and the portfolios belonging to the efficient frontier of drawdown risk portfolios (EF_PPDDR) are generated using the standard techniques of portfolio optimization available in the art.

In one exemplary embodiment, the present invention uses as portfolio constituents the assets belonging to a market benchmark (i.e., a single market index, like an equity index, a commodity index, a bond index, etc) or a composite market benchmark (i.e., an index composed by using and weighting at least two single market indexes). By using the systems and methods developed in the present invention, it is possible to differently weight the asset belonging to the said market benchmark, or the said composite market benchmark. In one embodiment, the weights are derived by the application of one, or a weighted mix, of the dimensions of the drawdown risk budgeting framework developed in the present invention. The resultant portfolio shows, on average, risk-adjusted returns better than the original single market benchmark or the composite market benchmark. That useful result has a rational explanation and it is provided by the improvement delivered by the focus on the drawdown dimensions (for example, the portfolio constituents with higher drawdown correlation ρ_{dd} between them and/or higher specific Drawdown Risk Measure, DDRM, will be underweighted with respect to the weights that the constituent assets have in the market benchmark, and viceversa). The stronger the relationship of the benchmark's assets in their co-movement on the downside, the more difficult will be for the same market benchmark to recover the losses suffered: this is also due to the adverse compounding returns effect (i.e., if a market benchmark or a portfolio lose 50% of its value, it must have a subsequent return of 100% just to recover its original value). In another exemplary embodiment, the behaviour of the portfolio derived from the application of one, or a weighted mix, of the dimensions of the drawdown risk budgeting framework developed in the present invention can be summarized in an index, whose behaviour is enhanced, in term of risk-adjusted returns, vs. the market benchmark (i.e. enhanced index).

In one aspect, the measure of correlation selected by the portfolio analyst for being used by the system and method of the present invention, instead of the drawdown correlation ρ_{dd}, can be another measure of correlation, like Kendall's Tau, Pearson's rho, etc. In an exemplary embodiment, the measure of correlation used by the system and method of the present invention is the higher (i.e., the more conservative from a risk standpoint) between different measures of correlation.

The advantage of using the system and method of the present invention for weighting set of securities (or group of securities) is the higher risk-adjusted return (with respect to the original market index) obtained by focusing on the drawdown risk budgeting dimensions. The rational explanation of the higher risk-adjusted return is the following: pairs of assets with strong drawdown correlation between them coupled with high drawdown risk show a persistent difficulties of recovering previous losses, due to the strong non-linear adverse effect of the compounding return: in order to recover a loss of 20% (50%) a positive performance of 25% (100%) is needed. The drawdown risk budgeting approaches operate by underweighting assets with strong drawdown correlation and/or higher drawdown risk. In that way the system and method of the present invention reduce the exposure of the portfolio to these assets, with the advantage of less portfolio drawdown and quicker drawdown recovery.

The performance and results of the portfolio built with this new set of weights can be described and invested as an Index (or Enhanced Index). Assuming a starting value of 1000, the Index (or Enhanced Index) will vary according to the weighted performance of the underlying constituents, whose weights are derived from the application of the methods developed with the present invention (FIGS. 2.2 and 2.3).

The system and method of the present invention then allow the portfolio analyst to rebalance the portfolio weights as new data regarding the underlying securities (or group of securities) become available. The rebalancing can be done according to one of the standard methods available in the art (i.e., calendar rebalancing, threshold rebalancing, a mix of both, etc). The new weights post-rebalancing are then applied to continue the historical series of the Index (or Enhanced Index).

In another exemplary embodiment of the present invention, the drawdown risk budgeting framework can be deployed both in absolute and/or relative return space (i.e. relative return vs. a single market benchmark or a composite/multi-asset market benchmark). In this embodiment the inputs for the computer systems and methods of the present invention are based on relative drawdowns instead of absolute drawdowns.

The description of the present invention and its embodiments has been provided for illustration purpose only. A person skilled in the relevant art can recognize that other components and configurations may be used without departing from the scope and spirit of the present invention.

### BRIEF DESCRIPTION OF THE DRAWINGS/FIGURES

The features and usefulness of the invention are illustrated in the drawings and the detailed description that follows.

FIG. 1. is a process flow diagram of the generation of measure of non normal Parametric Portfolio Drawdown Risk Measures (PPDDR).

FIG. 2 is a process flow diagram of the Drawdown Risk Budgeting—DRB, useful for generation of portfolios' weights based on the Equalisation (E) of the corresponding drawdown risk budgeting dimensions

FIG. 3 is a process flow diagram of the generation of portfolios' weights based on the efficient frontier of drawdown risk portfolios (EF_PPDDR).

### DETAILED DESCRIPTION OF EMBODIMENTS

Several exemplary embodiments of the present invention are discussed in this detailed description.

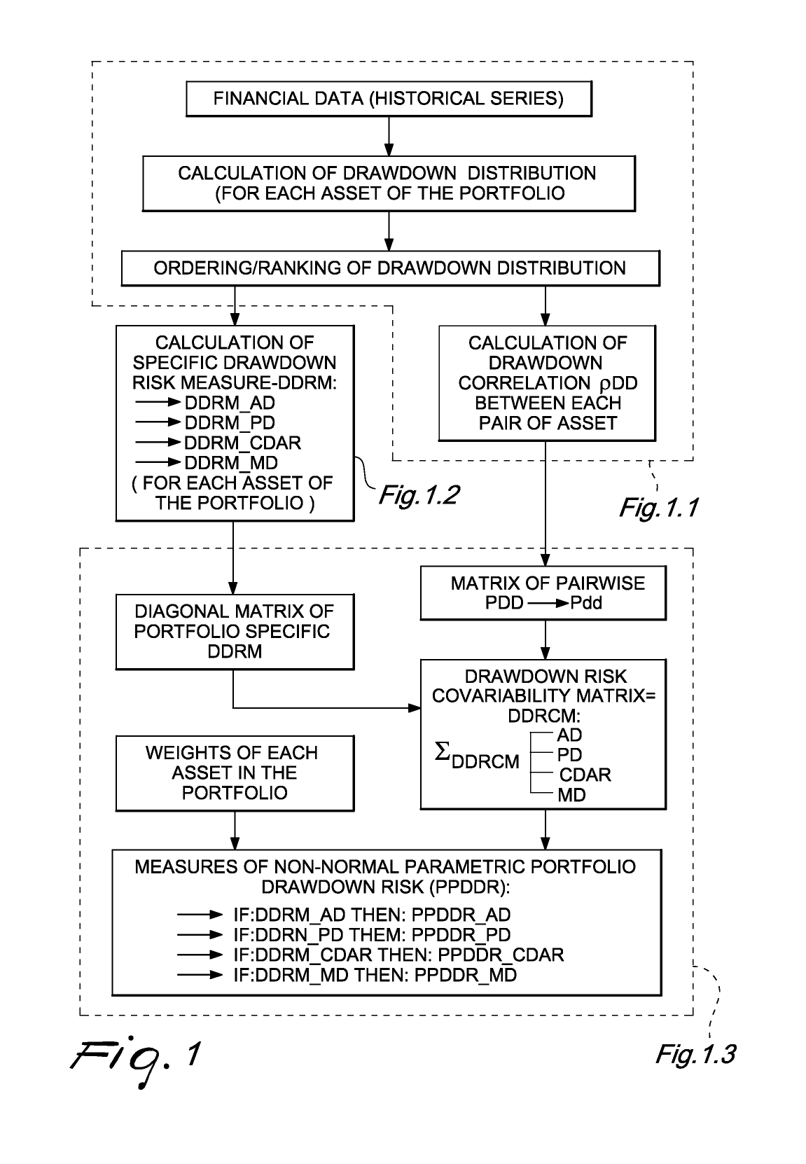

FIG. 1 depicts a process flow diagram of the generation of new risk measures of non normal Parametric Portfolio Drawdown Risk Measures (PPDDR). The portfolio analyst (i.e., the portfolio manager, or the asset allocator, or the risk manager, or the portfolio analyst) can use the system and method of the present invention to generate these new risk measures, given the following steps.

FIG. 1.1 Calculation of Drawdown Correlation

In an exemplary embodiment of the present invention, given a set of securities and/or asset classes, each with its own historical series of price Pₜ, as of time 0≦t≦T, the drawdown DD_{T} is defined as:

$${DD}_{T} = ( {P}_{T} - {max {P}_{t}}_{0 \leq t \leq T} ) \frac{1}{{max {P}_{t}}_{0 \leq t \leq T}} \qquad [ 1 ]$$

In order to calculate the drawdown correlation ρ_{dd} between two generic random variables X and Y, and assuming for simplicity no tied ranks, we need to separately order all the DDₜ(X) (with 0≦t≦T) for the variable X in a decreasing order and then assign a rank R_{i,X}=i/n, with 0≦i≦n to each DD_{t,X}, with n=T and R₁>R₂> . . . >Rₙ representing the sorted decreasing order of each DDₜ(X).

Having obtained all the possible ranks Rᵢₓ for the drawdown distribution of X, the calculation of drawdown correlation ρ_{dd} is performed by associating at each Rᵢₓ the corresponding rank R_{iY} of the drawdown distribution of the variable Y. The drawdown correlation ρ_{dd} is obtained by applying the Spearman's rank correlation to the ordered drawdown distributions, and its result is invariant to the variable ordered first. For the calculation of ρ_{dd}, lets define dᵢ as dᵢ=R_{i,X}−R_{i,Y|i,X}, that is the difference between the drawdown ranks of the corresponding value of the variables DDₜ(X) and DDₜ(Y). Then the drawdown correlation ρ_{dd} is calculated as follow:

$${ρ}_{dd} = 1 - \frac{6 {\sum }_{i}^{n} {d}_{i}^{2}}{n ( {n}^{2} - 1 )} , with {d}_{i} = {R}_{i , X} - {R}_{i , Y \vert i , X} \qquad [ 2 ]$$

The correlation between drawdown ranks overcomes some of the limitation of the common linear correlation coefficient. Only if two assets are fully linearly correlated the Pearson's rho is equal to 1 and the portfolio risk will be the sum of the two single risks.

Whereas the use of Pearson's rho is limited to linear relationship between variables, one advantage of using the correlation between drawdown ranks leans on its ability to deal with both linear and non-linear (but monotonic) association, the latter a common characteristic of financial time series that show a tendency to dislocations and to a common non-linear behaviour during phase of market stress vs a more linear behaviour during ‘normal’ market environments. Another advantage of using the correlation between drawdown ranks is its non-parametric nature: it doesn't need distributional assumptions, whereas Pearson's rho is a parametric measure that assumes that the variables are multivariate normally distributed, a very strong assumption (not only) during stressed market environments. The correlation between drawdown ranks instead can handle the non-normality of drawdown distributions. Moreover the correlation between drawdown ranks is less exposed to the effect of outliers given its focus on ranked data. As Pearson's correlation coefficient, the drawdown correlation ρ_{dd} is bounded between −1 and +1, and it is symmetric (i.e., it doesn't change if the two variables are exchanged). In case of monotonic variables a value of zero signals no association between ranks, while a value of +1 (−1) signals perfect positive (negative) association of ranks.

FIG. 1.2 Calculation of Specific Drawdown Risk Measures—DDRM

Some Drawdown Risk Measures has been studied in the art. These measures can be applied to a single financial instrument or to a portfolio of said instruments.

The specific Drawdown Risk Measure_Average Drawdown (DDRM_AD) can be defined as:

$${DDRM}_{—} AD = AD = \frac{1}{T} {\int }_{0}^{T} DD ( t ) d t \qquad [ 3 ]$$

The specific Drawdown Risk Measure_Percentile Drawdown (DDRM_PD) can be defined for a given probability level. Let αε(0,1) be that probability level. The Percentile Drawdown at level α is then defined as

DDRM_PD=PD=inf{x|P[DD>x]≦α} [4]

The level of α is often selected in the range 0.005%-10%.

The specific Drawdown Risk Measure_Conditional Drawdown at Risk (DDRM_CDAR) can be defined for a given small probability level. Let αε(0,1) be that probability level. The Conditional Drawdown at Risk at level α is the mean of the worst α-drawdowns. It is defined as

$$\begin{matrix}{DDRM}_{—} CDAR = CDAR = λ PD + ( 1 - λ ) {CDAR}^{+} & [ 5 ] \\ λ = \frac{P [ DD \geq PD ] - α}{α} & [ 5.1 ] \\ {CDAR}^{+} = E [ DD \vert DD > PD ] & [ 5.2 ]\end{matrix}$$

In Eq. 5.2 E[ ] denote the expected value for the variable in brackets.

For continuous distribution, the CDAR is defined has the expected drawdown given that the Percentile Drawdown has been exceeded. A general formulation, also valid for discrete distributions, is given in Eq. 5.: a weighted average of Percentile Drawdown and the expected value of all the drawdowns strictly exceeding the PD. In case of continuous distributions the value of λ is zero.

The specific Drawdown Risk Measure_Maximum Drawdown (DDRM_MD) can be defined as:

$${DDRM}_{—} MD = {MD}_{T} = {min {DD}_{T}}_{0 \leq t \leq T} \qquad [ 6 ]$$

FIG. 1.3 Calculation of Measures of Non-Normal Parametric Portfolio Drawdown Risk—PPDDR

In one exemplary embodiment of the present invention, the drawdown correlation ρ_{dd} described above can be extended to higher dimension by writing an n×n matrix of the pairwise drawdown correlations P_{dd}, in the same way as for linear correlation.

The drawdown correlation matrix P_{dd} is symmetric, and with diagonal entries of 1. By using the drawdown correlation matrix P_{dd} and a diagonal matrix of the absolute values of a specific Drawdown Risk Measure (DDRM) the present invention develops a new matrix DDRCM, Σ_{DDRCM}, named Drawdown Risk Covariability Matrix (DDRCM), that is akin to the classic variance-covariance matrix, but calculated on the drawdown dimensions DDRM and P_{dd} already defined.

In one exemplary embodiment, if the specific Drawdown Risk Measures selected by the portfolio analyst and/or risk manager is the Average Drawdown (DDRM_AD), then the method and system of the present invention calculate:
the Drawdown Risk Covariability Matrix_Average Drawdown (DDRCM_AD) and
the portfolio risk measure named non-normal Parametric Portfolio Drawdown Risk_Average Drawdown (PPDDR_AD), by taking the square root of a scalar formed by the multiplication of the row vector w of the portfolio weights of financial instruments considered for the inclusion in the portfolio and of Drawdown Risk Covariability Matrix_Average Drawdown (DDRCM_AD) and a column vector w of the portfolio weights, as follow:

PPDDR_AD={square root over (w^{T}Σ_{DDRCM}_{_{—}}_{AD}w)}=\sqrt{w^{T}diag(AD)P_{DD}diag(AD)w} [7]

In one exemplary embodiment, if the specific Drawdown Risk Measures selected by the portfolio analyst and/or risk manager is the Percentile Drawdown (DDRM_PD), then the method and system of the present invention calculate:
the Drawdown Risk Covariability Matrix_Percentile Drawdown (DDRCM_PD) and
the portfolio risk measure named non-normal Parametric Portfolio Drawdown Risk_Percentile Drawdown (PPDDR_PD), by taking the square root of a scalar formed by the multiplication of the row vector w of the portfolio weights of financial instruments considered for the inclusion in the portfolio and of Drawdown Risk Covariability Matrix_Percentile Drawdown (DDRCM_PD) and a column vector w of the portfolio weights, as follow:

PPDDR_PD={square root over (w^{T}Σ_{DDRCM}_{_{—}}_{PD}w)}=\sqrt{w^{T}diag(PD)P_{DD}diag(PD)w} [8]

In one exemplary embodiment, if the specific Drawdown Risk Measures selected by the portfolio analyst and/or risk manager is the Conditional Drawdown at Risk (DDRM_CDAR), then the method and system of the present invention calculate:
the Drawdown Risk Covariability Matrix_Conditional Drawdown at Risk (DDRCM_CDAR) and
the portfolio risk measure named non-normal Parametric Portfolio Drawdown Risk_Conditional Drawdown at Risk (PPDDR_CDAR), by taking the square root of a scalar formed by the multiplication of the row vector w of the portfolio weights of financial instruments considered for the inclusion in the portfolio and of Drawdown Risk Covariability Matrix_Conditional Drawdown at Risk (DDRCM_CDAR) and a column vector w of the portfolio weights, as follow:

PPDDR_CDAR={square root over (w^{T}Σ_{DDDRCM}_{_{—}}_{CDAR}w)}=\sqrt{w^{T}diag(CDAR)P_{DD}diag(CDAR)w} [9]

In one exemplary embodiment, if the specific Drawdown Risk Measures selected by the portfolio analyst and/or risk manager is the Maximum Drawdown (DDRM_MD), then the method and system of the present invention calculate:
the Drawdown Risk Covariability Matrix_Maximum Drawdown (DDRCM_MD) and
the portfolio risk measure named non-normal Parametric Portfolio Drawdown Risk_Maximum Drawdown (PPDDR_MD), by taking the square root of a scalar formed by the multiplication of the row vector w of the portfolio weights of financial instruments considered for the inclusion in the portfolio and of Drawdown Risk Covariability Matrix_Maximum Drawdown (DDRCM_MD) and a column vector w of the portfolio weights, as follow:

PPDDR_MD={square root over (w^{T}Σ_{DDDRCM}_{_{—}}_{MD}w)}=\sqrt{w^{T}diag(MD)P_{DD}diag(MD)w} [10]

According to one aspect, the portfolio risk measures named non-normal Parametric Portfolio Drawdown Risk (PPDR) above, are linear homogeneus in the portfolio weights: that is, if all the weights are multiplied by a constant k, the resultant PPDDR will also be scaled by the same constant k.

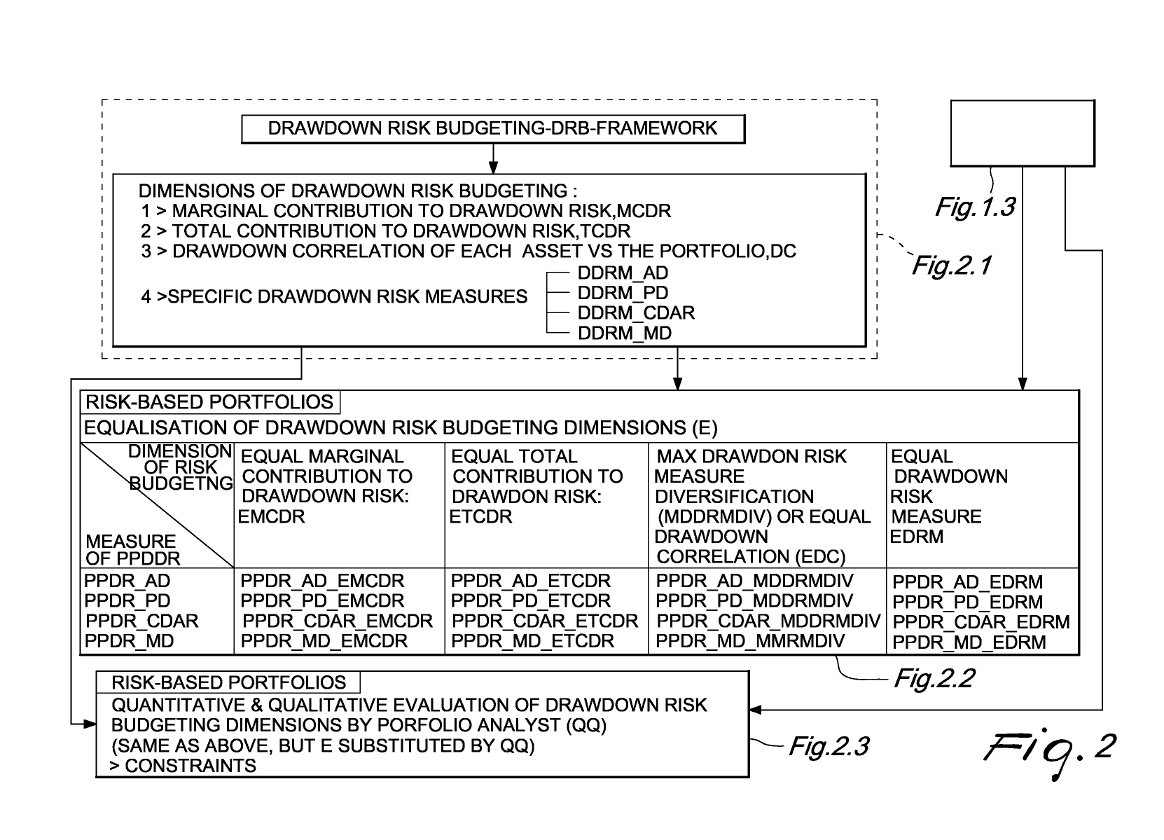

FIG. 2 Drawdown Risk Budgeting Framework—DRB

In one exemplary embodiment, the availability of the portfolio risk measures named non-normal Parametric Portfolio Drawdown Risk (PPDDR) described above, establish a new risk budgeting framework based on drawdown (Drawdown Risk Budgeting—DRB), given the analytical understanding regarding how the estimated non-normal PPDDR of a portfolio is related to the drawdown characteristics of the individual instruments within the same portfolio.

That result is useful because provides the portfolio analyst (and/or risk manager, etc.) with a new set of risk information for portfolio construction and risk management. These risk information, being explicitly focused on drawdown correlation, drawdown risk measures and drawdown contribution of each portfolio constituents to the estimated non-normal PPDDR, provides a more robust and effective approach in constructing portfolios that are less exposed to drawdown risk and with, on average, better risk-adjusted performance than the variance-covariance counterparts ubiquitously available in the art.

In one embodiment, this kind of risk information constitute the building blocks for establishing a new risk budgeting framework—DRB—that works in the drawdown dimensions instead of the volatility dimensions conventionally used in the art.

FIG. 2.1 Dimensions of Drawdown Risk Budgeting

In one exemplary embodiment of the present invention, from Eq. 7-10. we can get the formulation for the marginal and total contribution to the portfolio total risk, estimated by the risk measures named non-normal Parametric Portfolio Drawdown Risk (PPDDR)

The marginal contribution to PPDDR of each asset i, MC−PPDDRᵢ, can be written in vector form as

$$MC - PPDDR = \frac{\partial PPDDR}{\partial w} = \frac{{Σ}_{DDRCM} w}{\sqrt{{w}^{T} {Σ}_{DDRCM} w}} \qquad [ 11 ]$$

where each marginal contribution MC−PPDDRᵢ provides the impact on portfolio risk measure PPDR given an infinitesimal increase in the asset's i weight while keeping the other weights fixed, as follow:

ΔPPDDR≈MC−PPDDRᵢΔwᵢ [12]

The portfolio that equalize the marginal contribution of each asset i to the portfolio risk measure PPDDR is the Equal Marginal Contribution to PPDDR (EMCDR), that is analogous to its variance-covariance counterpart (i.e., the minimum variance portfolio), but calculated in the new drawdown dimensions explained above.

If we restate the portfolio PPDDR as

$$PPDDR = {w}^{T} \frac{{Σ}_{DDRCM} w}{\sqrt{{w}^{T} {Σ}_{DDRCM} w}} \qquad [ 13 ]$$

that means the we can rewrite the portfolio PPDDR as the sum of total risk contribution of each portfolio asset i, TC−PPDDRᵢ, each defined as the MC−PPDDRᵢ multiplied by the corresponding weight wᵢ,

$$PPDDR = {\sum }_{i = 1}^{N} TC - {PPDDR}_{i} = {w}_{i} MC - {PPDDR}_{i} \qquad [ 14 ]$$

The portfolio that equalize the total contribution of each asset i to the portfolio risk measure PPDDR is the Equal Total Contribution to PPDDR (ETCDR), that is analogous to its variance-covariance counterpart (i.e., the equal risk contribution portfolio), but calculated in the new drawdown dimensions explained above.

The ETCDR portfolio is the portfolio where all the TC−PPDDRᵢ are equal.

$$ETCDR \text{:} TC - {PPDDR}_{i} = TC - {PPDDR}_{j} = k ∀ i , j with k = \frac{1}{N} \qquad [ 15 ]$$

Essentially the ETCDR portfolio is the portfolio where the Gini coefficient in the TC−PPDDRᵢ dimension is minimized. Whereas the alternatives available in the art work on volatilities and correlations, the EMCDR and ETCDR methods introduced by the present invention work on of equalisation of the drawdown marginal and total contributions to PPDDR.

In another exemplary embodiment, the present invention develop the Equal Drawdown Risk Measure portfolio (EDRM), where it is assumed that all the assets of a portfolio have identical pairwise drawdown correlation ρ_{dd} but different specific Drawdown Risk Measure (DDRM). In that case the weight wᵢ of each asset i is directly given by the ratio between the inverse of the DDRM of asset i and the sum of the inverse of all the j assets' DDRM,

$${w}_{i , EDRM} = \frac{abs ⌊ {DDRM}_{i , T}^{- 1} ⌋}{{Σ}_{j = 1}^{N} abs [ {DDRM}_{j , T}^{- 1} ]} \qquad [ 16 ]$$

In one exemplary embodiment, the present invention develop a method and system for the calculation of the weights of the Max Drawdown Risk Measure Diversification portfolio (MDDRMDiv). The MDDRMDiv is the portfolio that maximize the Drawdown Diversification Ratio, DDR. The DDR is the ratio between the weighted average of each asset's specific Drawdown Risk Measure (DDRM) and the portfolio PPDDR:

$$DDR = \frac{{weighted}_{—} {average}_{—} {of}_{—} DDRM}{{portfolio}_{—} PPDDR} = \frac{{\sum }_{i = 1}^{n} {w}_{i} {DDRM}_{i}}{PPDDR} \qquad [ 17 ]$$

Because the denominator takes into account the drawdown correlations ρ_{dd}, while the numerator ignores the relationships between the portfolio constituents, the DDR is higher when the portfolio PPDDR is low relative to the weighted average of each asset's specific Drawdown Risk Measure (DDRM), due to less than perfect drawdown correlations. The MDDRMDiv portfolio works on the drawdown correlation dimension: each asset selected for inclusion in the portfolio has the same (and lowest) drawdown correlation ρ_{dd}_{_{—}}ᵢ_{_{—}}_{MDDRMDIV} to the MDDRMDiv portfolio, whereas the assets excluded have higher drawdown correlation. The focus on the correlation differentiates the MDDRMDiv from other drawdown risk-based portfolios, that are instead focused on obtaining the same marginal contribution to PPDDR (EMCDR) or in obtaining the same values in the total drawdown risk contribution dimension (ETCDR).

FIG. 2.2 Risk-Based Portfolios: Equalisation of Drawdown Risk Budgeting Dimensions

In another exemplary embodiment, the present invention develop a system and method for building risk-based portfolios by combining a specific dimension of drawdown risk budgeting and a specific portfolio drawdown risk measure PPDDR, as in FIG. 2.2.

The portfolio analyst and/or risk manager can use the system and method of the present invention selecting one of the measures of non-normal PPDDR:
PPDDR_AD of Eq. 7, or
PPDDR_PD of Eq. 8, or
PPDDR_CDAR of Eq. 9, or
PPDDR_MD of Eq. 10.

The portfolio analyst (and/or risk manager, etc.) can then select one of the dimension of Drawdown Risk Budgeting:
MC−PPDDRᵢ of Eq. 14 or
TC−PPDRᵢ of Eq. 15 or
the w_{i,EDRM} of the EDRM portfolio of Eq. 16, or
the DDR, ρ_{dd}_{_{—}}ₜ_{_{—}}_{MDDRMDIV} of the MDDRMDiv portfolio of Eq. 17.

The system and method of the present invention then:

find the weights of each asset within the risk-based portfolio such that the conditions of Eq. 14 to 17 are satisfied, using standard optimization techniques available in the art;
calculate all the relevant drawdown risk budgeting dimensions useful for the portfolio analyst (and/or risk manager, etc.) in evaluating the risk of the portfolio and the risk and relationship of each single asset, between them and the portfolio as a whole.

The equalisation of a specific drawdown risk budgeting dimensions and the resultant portfolio weights can be considered as the starting point portfolio, or the ‘neutral’ portfolio (or the benchmark portfolio) by the portfolio analyst which doesn't want that each asset within the portfolio be overexposed or underexposed to the selected drawdown risk budgeting dimension, or has ‘no view’ on the selected drawdown risk budgeting dimension. The portfolio analyst can then use the ‘neutral’ weigths directly for portfolio construction.

FIG. 2.3 Qualitative and/or Quantitative Evaluation and Selection of Exposure to Drawdown Risk Budgeting Dimensions by the Portfolio Analyst.

In another exemplary embodiment, the portfolio analyst can use the system and method of the present invention in order to modify the ‘neutral’ weigths already obtained in the previous step given its Qualitative and/or Quantitative choices or views regarding:
the exposure of each asset within the portfolio to the selected Drawdown Risk Budgeting dimensions;
portfolio constraints in terms of risk concentration and/or weight concentration;
portfolio constraints in terms of absolute level of portfolio risk;
portfolio constraints in terms of relative level of portfolio risk vs. a market benchmark;
portfolio constraints in terms of liquidity of the underlying portfolio components;
other constraints common in the art.

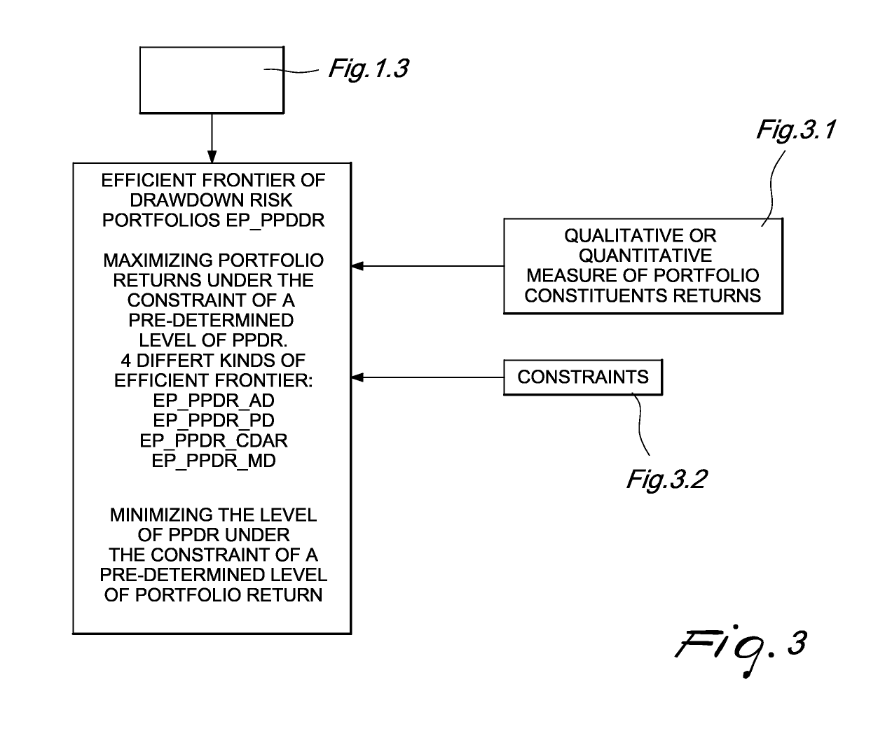

FIG. 3 Efficient Frontier of Non-Normal Parametric Portfolio Drawdown Risk Portfolios

By using the non-normal Parametric Portfolio Drawdown Risk measures already depicted in FIG. 1.3, the portfolio analyst can build non-normal PPDDR efficient portfolios, instead of the classic mean-variance efficient portfolios and their variations available in the art. In that way the present invention establish a system and method for building a set of portfolios that, based on the selection of a measure of non-normal PPDDR (i.e. one of the new risk measures developed in the present invention), perform a maximization of a measure of portfolio returns, subject to a constraint given by the level of the non-normal PPDDR measure, the latter level selected by the portfolio analyst. The maximization is performed with standard optimization techniques available in the art.

The measure of portfolio returns can be qualitatively and/or quantitatively selected by the portfolio analyst given its quantitative and/or qualitative assessment of the returns of each single portfolio constituents (FIG. 3.1).

In FIG. 3.2 the portfolio analyst can select one or more of the portfolio constraints already depicted in FIG. 2.3.

The outputs of the performed maximization provided by the system and method of the present invention are the portfolio weights and the drawdown risk budgeting dimensions developed in the present invention.

In one embodiment of the present invention, the portfolio analyst can select a measure of portfolio return and a target level for this selected measure of portfolio return. By using the system and method of the present invention the portfolio analyst can then select a measure of non-normal PPDDR (i.e. one of the new risk measures developed in the present invention) and then build a portfolio that, given the target level for the selected measure of portfolio return, minimizes the selected measure of non-normal PPDDR. The outputs of the performed minimization are the portfolio weights and the drawdown risk budgeting dimensions developed in the present invention.

There are 4 different drawdown risk efficient frontiers that can be build with the system and method of the present invention.

If the portfolio analysts select the portfolio risk measure PPDDR_AD, then the corresponding efficient frontier portfolio is the Efficient Frontier_Parametric Portfolio Drawdown Risk_Average Drawdown (EF_PPDDR_AD).

If the portfolio analysts select the portfolio risk measure PPDDR_PD, then the corresponding efficient frontier portfolio is the Efficient Frontier_Parametric Portfolio Drawdown Risk_Percentile Drawdown (EF_PPDDR_PD).

If the portfolio analysts select the portfolio risk measure PPDDR_CDAR, then the corresponding efficient frontier portfolio is the Efficient Frontier_Parametric Portfolio Drawdown Risk_Conditional Drawdown at Risk (EF_PPDDR_CDAR).

If the portfolio analysts select the portfolio risk measure PPDDR_MD, then the corresponding efficient frontier portfolio is the Efficient Frontier_Parametric Portfolio Drawdown Risk Max Drawdown (EF_PPDDR_MD).

Indexing and Rebalancing

Given a pre-defined set of securities (or group of securities like industry sectors, maturity sectors for debt instruments, rating sectors, commodity sectors, a market segment, etc) belonging to a stock market index, or a bond market index, or a commodity index, etc., or a composite built with different securities and/or market indices (and or ETFs, futures contracts, mutual funds, hedge funds, funds of funds, funds, etc) the system and method of the present invention allow the construction of a portfolio whose weights are derived from the application of the method and system developed with the present invention (FIGS. 2.2 and 2.3).

The pre-defined set of securities belonging to a market index are generally weighted according to their weighted market capitalization (in case of stocks indices) or their weighted amount issued (in case of bond indices) or a measure of production or volume (in case of commodity indices, etc.), without any regard to the risk characteristics nor to the drawdown risk dimensions.

The advantage of using the system and method of the present invention for weighting set of securities (or group of securities) is the higher (on average) risk-adjusted return (with respect to the original market index) obtained by focusing on the drawdown risk budgeting dimensions. The rational explanation of the higher risk-adjusted return is the following: pairs of assets with strong drawdown correlation between them coupled with high drawdown risk show a persistent difficulties of recovering previous losses, due to the strong non-linear adverse effect of the compounding return: in order to recover a loss of 20% (50%) a positive performance of 25% (100%) is needed. The drawdown risk budgeting approaches operate by underweighting assets with strong drawdown correlation and/or higher drawdown risk, and viceversa. In that way the system and method of the present invention reduce the exposure of the portfolio to these assets, with the advantage of less portfolio drawdown and quicker drawdown recovery.

The performance and results of the portfolio built with this new set of weights can be described and invested as an Index (or Enhanced Index). Assuming a starting value of 1000, the Index (or Enhanced Index) will vary according to the weighted performance of the underlying constituents, whose weights are derived from the application of the methods developed with the present invention (FIGS. 2.2 and 2.3).

The system and method of the present invention then allow the portfolio analyst to rebalance the portfolio weights as new data regarding the underlying securities (or group of securities) become available. The rebalancing can be done according to one of the standard methods available in the art (i.e., calendar rebalancing, threshold rebalancing, a mix of both, etc).

The new weights post-rebalancing are then applied to continue the historical series of the Index (or Enhanced Index).

### COPYRIGHT NOTICE

It is understood that a portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

What is claimed is:

1. A computer-implemented method for estimating the risk of a portfolio, comprising the steps of:
providing, for said portfolio, a set of financial assets and the corresponding historical series;
for each one of said assets, calculating the drawdown distribution (DD);
ordering sorting said drawdowns (DD);
associating a rank (R) with each one of said drawdowns (DD);
calculating the drawdown correlation (ρDD) of each pair of said drawdowns (DD) of said assets;
calculating the drawdown correlation matrix (PDD) starting from said drawdown correlation (ρDD) of each pair of said drawdowns (DD) of said assets;
calculating the drawdown risk measure (DDRM) for each one of said assets;
calculating the diagonal matrix constituted by the drawdown risk measures (DDRM) of each individual asset;
calculating the drawdown risk covariability matrix (DDRCM) in the dimensions of drawdown risk measure (DDRM) and of drawdown correlation matrix (PDD);
providing the weights (w) of each asset;
multiplying the row vector of said weights (w) of each asset, said drawdown risk covariability matrix (DDRCM) and the column vector of said weights (w) of each asset, the square root of the scalar of the result of said multiplication being an estimate of the risk of said portfolio (non-normal parametric portfolio drawdown risk PPDDR).

2. The computer-implemented method according to claim 1, wherein said drawdown risk measure (DDRM) is selected from the group constituted by:
average drawdown (DDRM_AD), said average drawdown (DDRM_AD) being the average of said drawdowns (DD);
percentile drawdown (DDRM_PD), said percentile drawdown (DDRM_PD) being obtained by sorting all the drawdowns in increasing order, assigning to each drawdown thus sorted its percentile value and selecting the drawdown that corresponds to a desired percentile value;
conditional drawdown-at-risk (DDRM_CDAR), said conditional drawdown-at-risk (DDRM_CDAR) being obtained by sorting all the drawdowns in increasing ascending order, assigning to each drawdown thus sorted its percentile value, selecting the drawdowns that are worse than a desired percentile value and calculating the average of said worset drawdowns; and
maximum drawdown (DDRM_MD), said maximum drawdown (DDRM_MD) being obtained by sorting all the drawdowns in increasing ascending order and selecting the worst drawdown.

3. A computer-implemented method for formulating risk budgeting, comprising the steps of:
providing, for said portfolio, a set of financial assets and the corresponding historical series;
for each one of said assets, calculating the drawdown distribution (DD);
ordering sorting said drawdowns (DD);
associating a rank (R) with each one of said drawdowns (DD);
calculating a drawdown correlation (ρDD) of each pair of said drawdowns (DD) of said assets;
calculating a drawdown correlation matrix (PDD) starting from said drawdown correlation (ρDD) of each pair of said drawdowns (DD) of said assets;
calculating a drawdown risk measure (DDRM) for each one of said assets;
calculating a diagonal matrix constituted by the drawdown risk measures (DDRM) of each individual asset;
calculating a drawdown risk covariability matrix (DDRCM) in the dimensions of drawdown risk measure (DDRM) and of drawdown correlation matrix (PDD);
providing weights (w) of each asset;
multiplying a row vector of said weights (w) of each asset, said drawdown risk covariability matrix (DDRCM) and a column vector of said weights (w) of each asset, a square root of the scalar of the result of said multiplication being an estimate of the risk of said portfolio (non-normal parametric portfolio drawdown risk PPDDR);
providing a drawdown risk budgeting dimension selected from the group constituted by:
marginal contribution to drawdown risk (MCDR), said marginal contribution to drawdown risk (MCDR) of an asset (i) providing the impact on said estimate of the risk of said portfolio (non-normal parametric portfolio drawdown risk PPDDR), given an infinitesimal increment in the weight of said asset (i), while keeping fixed the weights of the other assets of said portfolio;
total contribution to drawdown risk (TCDR), said total contribution to drawdown risk (MTCDR [sic]) being the portfolio risk expressed by said estimate of the risk of said portfolio (non-normal parametric portfolio drawdown risk PPDDR) as a sum of the total contributions of each asset (i) to said risk of said portfolio;
drawdown correlation (DC), said drawdown correlation (DC) being the correlation between the drawdown distribution of an individual asset (li) and that of said portfolio; and
specific drawdown risk measure (DDRM), said specific drawdown risk measure (DDRM) being selected from the group constituted by:
average drawdown (DDRM_AD), said average drawdown (DDRM_AD) being the average of said drawdowns (DD);
percentile drawdown (DDRM_PD), said percentile drawdown (DDRM_PD) being obtained by sorting all the drawdowns in increasing ascending order, assigning to each drawdown thus sorted its percentile value and selecting the drawdown that corresponds to a desired percentile value;
conditional drawdown-at-risk (DDRM_CDAR), said conditional drawdown-at-risk (DDRM_CDAR) being obtained by sorting all the drawdowns in increasing ascending order, assigning to each drawdown thus sorted its percentile value, selecting the drawdowns that are worse than a desired percentile value and calculating the average of said worset drawdowns; and
maximum drawdown (DDRM_MD), said maximum drawdown (DDRM_MD) being obtained by sorting all the drawdowns in increasing ascending order and selecting the worst drawdown;
assembling a risk-based portfolio starting from said estimate of the risk of said portfolio (non-normal parametric portfolio drawdown risk PPDDR) and from said drawdown risk budgeting dimension, the weights of said risk-based portfolio deriving from the equalization (E) of said drawdown risk budgeting dimension.

4. The computer-implemented method according to claim 3, wherein the weights of said risk-based portfolio are selected from the group constituted by:
equal marginal contribution to drawdown risk (EMCDR), in which the weights of the individual assets in the risk-based portfolio are derived from the equalization of the marginal contributions (marginal contributions to drawdown risk (MCDR)) of each individual asset to said drawdown risk of said risk-based portfolio;
equal total contribution to drawdown risk (ETCDR), in which the weights of the individual assets in said risk-based portfolio are derived from the equalization of the total contributions (total contributions to drawdown risk (TCDR)) of each individual asset to said drawdown risk of said risk-based portfolio;
maximum drawdown diversification (MDD, or equal drawdown correlation, EDC), in which the weights of the individual assets in said risk-based portfolio are derived from the simultaneous equalization and minimization of said drawdown correlation (DC) of each individual asset with said drawdown of said risk-based portfolio; and—equal drawdown risk measure (EDRM), wherein, assuming that all the assets in said risk-based portfolio have identical drawdown correlations (ρDD) but different specific drawdown risk measures (DDRM), the weight of each specific asset in said risk-based portfolio is provided by the ratio between the inverse of said specific drawdown risk measure (DDRM) of said specific asset and the harmonic mean of all the specific drawdown risk measures (DDRM) of all the assets that are present in said risk-based portfolio.

5. The computer-implemented method according to claim 3, further comprising the step of modifying the weights of said risk-based portfolio on the basis of a qualitative/quantitative parameter (QQ) selected from the group constituted by:
the exposure of each asset of said risk-based portfolio to said drawdown risk budgeting dimension;
portfolio constraints in terms of risk concentrations;
portfolio constraints in terms of concentration of said weights;
portfolio constraints in terms of absolute risk levels;
portfolio constraints in terms of relative risk with respect to a benchmark;
portfolio constraints in terms of liquidation capability of the individual assets or aggregations of assets of said risk-based portfolio;
additional constraints that can be specified by the user.

6. A computer-implemented method for building an efficient portfolio, comprising the steps of:
providing, for said portfolio, a set of financial assets and the corresponding historical series;
for each one of said assets, calculating a drawdown distribution (DD);
ordering sorting said drawdowns (DD);
associating a rank (R) with each one of said drawdowns (DD);
calculating a drawdown correlation (ρDD) of each pair of said drawdowns (DD) of said assets;
calculating a drawdown correlation matrix (PDD) starting from said drawdown correlation (ρDD) of each pair of said drawdowns (DD) of said assets;
calculating a drawdown risk measure (DDRM) for each one of said assets;
calculating a diagonal matrix constituted by the drawdown risk measure (DDRM) of each individual asset;
calculating a drawdown risk covariability matrix (DDRCM) in the dimensions of drawdown risk measure (DDRM) and of drawdown correlation matrix (PDD);
providing weights (w) of each asset;
multiplying a row vector of said weights (w) of each asset, said drawdown risk covariability matrix (DDRCM) and a column vector of said weights (w) of each asset, a square root of the scalar of the result of said multiplication being an estimate of the risk of said portfolio (non-normal parametric portfolio drawdown risk (PPDDR);
selecting said estimate of the risk of said portfolio (non-normal parametric portfolio drawdown risk PPDDR);
obtaining an efficient frontier of drawdown risk portfolios (EF_PPDDR).

7. The computer-implemented method according to claim 6, wherein said efficient frontier of drawdown risk portfolios (EF_PPDDR) is obtained by identifying determining the weights of said portfolio that maximize a measurement of the performance of said portfolio, under the constraint set by a desired target level for said risk estimate of said portfolio (non-normal parametric portfolio drawdown risk PPDDR).

8. The computer-implemented method according to claim 6, wherein said efficient frontier of drawdown risk portfolios (EF_PPDDR) is obtained by identifying the weights of said portfolio that minimize said estimate of the risk of said portfolio (non-normal parametric portfolio drawdown risk PPDDR), under the constraint set by a desired target level of performance of said portfolio.

9. The computer-implemented method according to claim 6, wherein said drawdown risk measure (DDRM) is selected from the group constituted by:
average drawdown (DDRM_AD), said average drawdown (DDRM_AD) being the average of said drawdowns (DD);
percentile drawdown (DDRM_PD), said percentile drawdown (DDRM_PD) being obtained by sorting all the drawdowns in increasing ascending order, assigning to each drawdown thus sorted its percentile value and selecting the drawdown that corresponds to a desired percentile value;
conditional drawdown-at-risk (DDRM_CDAR), said conditional drawdown-at-risk (DDRM_CDAR) being obtained by sorting all the drawdowns in increasing ascending order, assigning to each drawdown thus sorted its percentile value, selecting the drawdowns that are worse than a desired percentile value and calculating the average of said worset drawdowns; and
maximum drawdown (DDRM_MD), said maximum drawdown (DDRM_MD) being obtained by sorting all the drawdowns in increasing ascending order and selecting the worst drawdown.

10. The computer-implemented method according to claim 6, for building investable indexes that are representative of the performance and of the results of one of portfolios, the weights of which are determined in each instance (at a chosen portfolio rebalancing dates) on the basis of claim 6.

11. A computer program suitable adapted to perform execute the method for estimating the risk of a portfolio and determining the corresponding weights according to claim 1.
